(19) United States
(12) Patent Application Publication
(10) Pub. No.: US 2020/0048041 A1
(43) Pub. Date: Feb. 13, 2020

(54) ELEVATOR ELECTRICAL SAFETY ACTUATOR CONTROLLER

(71) Applicant: Otis Elevator Company, Farmington, CT (US)

(72) Inventors: Aurelien Fauconnet, Isdes (FR); Joachim Angoulevant, Saint Martin d'Abbat (FR)

(21) Appl. No.: 16/530,406

(22) Filed: Aug. 2, 2019

(30) Foreign Application Priority Data
Aug. 10, 2018 (EP) 18306102.7

(51) Int. Cl. B66B 5/18; B66B 1/34; B66B 5/04

(52) U.S. Cl. CPC B66B 5/18; B66B 5/04; B66B 1/3446

(57) ABSTRACT

Elevator systems are described. The elevator systems include an elevator car movable along guide rails along an elevator shaft, the car having a platform, a ceiling, and car structural members, with car panels arranged to define a cab, and a car operating panel therein. An overspeed safety system includes first and second safety brakes and electromechanical actuators, with the brakes operable to engage with the guide rails to stop movement of the elevator car. A control system is operably connected to the electromechanical actuators and configured to trigger the electromechanical actuators due to at least a detected overspeed event. The control system is located on top of the ceiling, within the ceiling, beneath the platform, within the platform, behind a car panel, or within the car operating panel.

### BACKGROUND

The subject matter disclosed herein generally relates to elevator systems and, more particularly, to safety systems that are installed in locations not typically employed.

Certain components of elevator cars are mounted to the exterior of the elevator car and thus may be difficult for mechanics to access and perform maintenance thereon. For example, safety blocks that engage with a guide rail may be located at the top of uprights of the frame of an elevator car, and thus access into the elevator shaft may be required to perform maintenance thereon. Further, such components may require additional space for the elevator car to operate within an elevator shaft.

For example, traditional safety requirements for elevator shafts have led to larger spaces both at the top and bottom of the elevator shaft, to enable safe access to components installed on the exterior of the elevator car. However, such enlarged spaces may be disadvantageous for architectural reasons. Thus, elevator manufacturers have attempted to reduce hoistway or elevator shaft overhead dimensions and pit depth while maintaining safety features. Mechanics currently go to the top of car, or on top thereof, or in the pit, for inspection or maintenance activity of various components of an elevator car system, including safety actuation systems. Thus, safety spaces or volumes are employed within the elevator shaft to protect a mechanic in the event of an emergency and thus require increased overhead and pit dimensions.

Typical elevator systems use governor overspeed systems coupled to a mechanical safety actuation module in order to activate in the event of a car overspeed event—i.e., to stop an elevator car that is travelling too fast. Such systems include a linking mechanism to trigger two car safeties simultaneously (i.e., on both guide rails). The governor is located either at the top of the hoistway or may be embedded on the elevator car. The safety actuation module is typically made by a rigid bar or linkage that is located on the car roof or below the car platform—i.e., spanning the width of the elevator car to link opposing sides at the guide rails. The location of the linkage requires that the safety components be located similarly (e.g., either above the car roof or below the car platform). Such installation impacts the extent to which the components extend above or below the elevator car, which in turn impacts the required operational space at the shaft top or in the pit.

### BRIEF SUMMARY

According to some embodiments, elevator systems are provided. The elevator systems include an elevator car movable along a first guide rail and a second guide rail within an elevator shaft, the elevator car having a car frame comprising a platform, a ceiling, a first car structural member, and a second car structural member the elevator car further comprising one or more car panels defining a cab and a car operating panel and an overspeed safety system. The overspeed safety system includes a first safety brake and a first electromechanical actuator operably connected thereto, wherein the first safety brake is operable to engage with the first guide rail to stop movement of the elevator car, a second safety brake and a second electromechanical actuator operably connected thereto, wherein the second safety brake is simultaneously operable with the first safety brake to engage with the second guide rail to stop movement of the elevator car, and a control system operably connected to the first electromechanical actuator and the second electromechanical actuator, the control system configured to trigger the first electromechanical actuator and the second electromechanical actuator due to at least a detected overspeed event, wherein the control system is located on top of the ceiling, within the ceiling, beneath the platform, within the platform, behind a car panel, or within the car operating panel.

In addition to one or more of the features described above, or as an alternative, further embodiments may include that a distance between the platform and the ceiling is defined as a car height H_{C}, the first safety brake and the first electromechanical actuator are positioned within the first car structural member within the car height H_{C}, and wherein the second safety brake and the second electromechanical actuator are positioned within the second car structural member within the car height H_{C}.

In addition to one or more of the features described above, or as an alternative, further embodiments may include that the first safety brake and the first electromechanical actuator are positioned at a respective upper installation height from the ceiling of the elevator car within the first car structural member and the second safety brake and the second electromechanical actuator are positioned at a respective upper installation height from the ceiling of the elevator car within the second car structural member.

In addition to one or more of the features described above, or as an alternative, further embodiments may include that the upper installation height of the first safety brake and the first electromechanical actuator and the upper installation height of the second safety brake and the second electromechanical actuator are the same upper installation height H_{U}.

In addition to one or more of the features described above, or as an alternative, further embodiments may include that the upper installation height H_{U} is about 500 mm.

In addition to one or more of the features described above, or as an alternative, further embodiments may include that the first safety brake and the first electromechanical actuator are positioned at a respective lower installation height from the platform of the elevator car within the first car structural member and the second safety brake and the second electromechanical actuator are positioned at a respective lower installation height from the ceiling of the elevator car within the second car structural member.

In addition to one or more of the features described above, or as an alternative, further embodiments may include that the lower installation height of the first safety brake and the first electromechanical actuator and the lower installation height of the second safety brake and the second electromechanical actuator are the same lower installation height H_{L}.

In addition to one or more of the features described above, or as an alternative, further embodiments may include that the lower installation height H_{L} is about 2000 mm.

In addition to one or more of the features described above, or as an alternative, further embodiments may include a communication line connecting the control system to the first electromechanical actuator and the second electromechanical actuator.

In addition to one or more of the features described above, or as an alternative, further embodiments may include that the communication line is at least one of a wired connection and a wireless connection.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited by the accompanying figures in which like reference numerals indicate similar elements.

FIG. 1 is a schematic illustration of an elevator system that may employ various embodiments of the present disclosure;

FIG. 2 is a prior art arrangement of an overspeed safety system for elevators;

FIG. 3A is an isometric illustration of an elevator car frame having an overspeed safety system in accordance with an embodiment of the present disclosure;

FIG. 3B is an enlarged illustrative view of a portion of the overspeed safety system of FIG. 3A;

FIG. 3C is the same view as FIG. 3B, but with a guide rail removed for clarity;

FIG. 4 is a schematic illustration of an overspeed safety system in accordance with an embodiment of the present disclosure illustration an installation location thereof;

FIG. 5 is a schematic illustration of an overspeed safety system in accordance with an embodiment of the present disclosure illustration an installation location thereof;

FIG. 6 is a schematic illustration of an overspeed safety system in accordance with an embodiment of the present disclosure illustration an installation location thereof.

### DETAILED DESCRIPTION

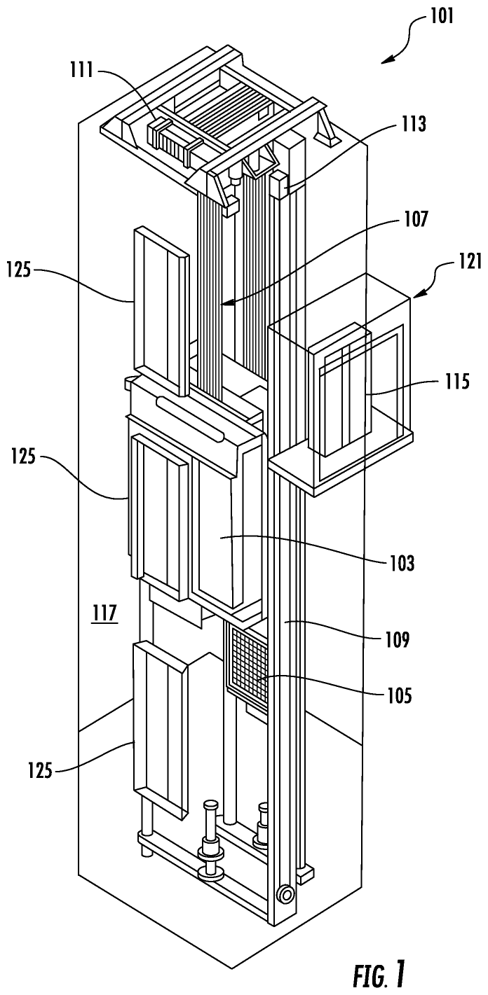

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter-weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

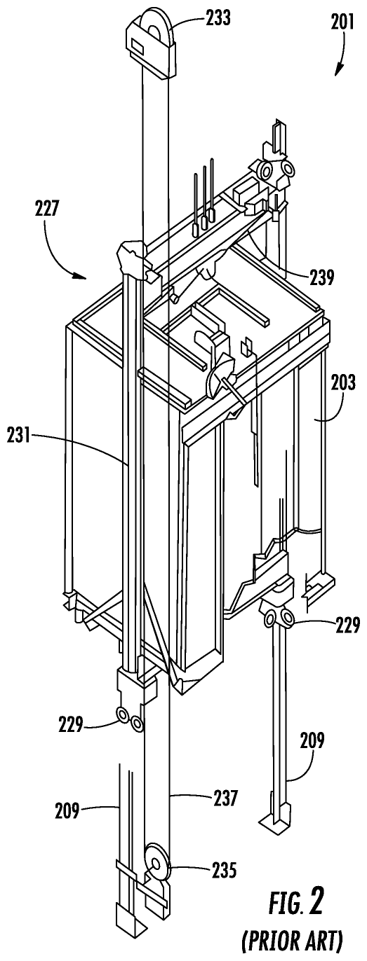

Turning to FIG. 2, a schematic illustration of a prior elevator car overspeed safety system 227 of an elevator system 201 is shown. The elevator system 201 includes an elevator car 203 that is movable within an elevator shaft along guide rails 209. In this illustrative embodiment, the overspeed safety system 227 includes a pair of braking elements 229 that are engageable with the guide rails 209. The braking elements 229 are actuated, in part, by operation of lift rods 231. The triggering of the braking elements 229 is achieved through a governor 233, typically located at the top of the elevator shaft, which includes a tension device 235 located within the pit of the elevator shaft with a cable 237 operably connecting the governor 233 and the tension device 235. When an overspeed event is detected by the governor, the overspeed safety system 227 is triggered, and a linkage 239 is operated to actuate both lift rods 231 simultaneously such that a smooth and even stopping or braking force is applied to stop the travel of the elevator car. The linkage 239, as shown, is located on the top of the elevator car 203. However, in other configurations, the linkage may be located below a platform (or bottom) of the elevator car. As shown, various components are located above and/or below the elevator car 203, and thus pit space and overhead space within the elevator shaft must be provided to permit operation of the elevator system 201.

Embodiments described herein are directed to providing elevator overspeed safety systems that do not extend above or below the elevator car, or at least minimize such extensions. Specifically, embodiments described herein are directed to locating various components of an overspeed safety system within a car height (i.e., between a platform/floor and top/ceiling) of an elevator car. The components may be located within the car structural member that is a vertical portion of the frame of the elevator car, to locate the elements proximate a guide rail while also eliminating the need for extensions in height above or below the elevator car. The car structural member extends between or is located between a car platform and a car ceiling. The car structural members may be frame elements or other structural components or supports of an elevator car/car frame, as will be appreciated by those of skill in the art.

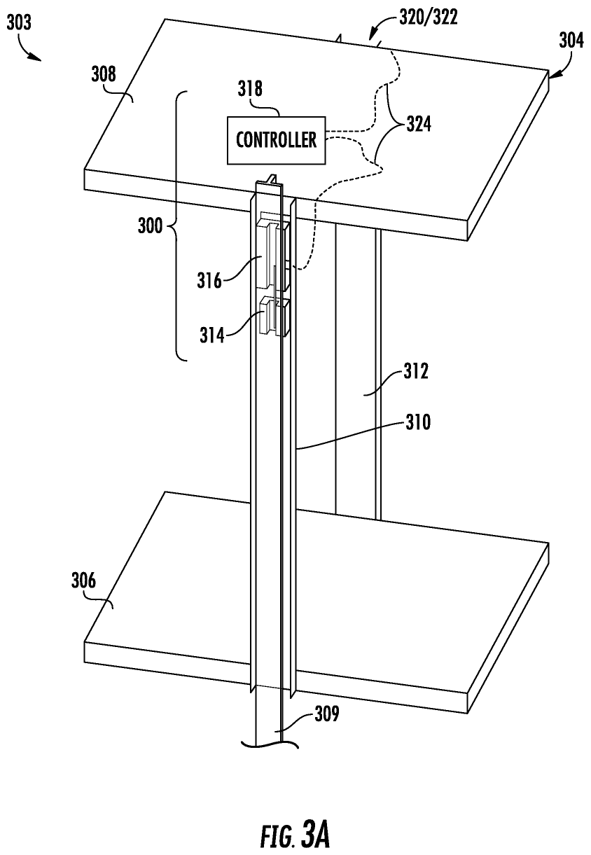

Turning now to FIGS. 3A-3C, schematic illustrations of an elevator car 303 having an overspeed safety system 300 in accordance with an embodiment of the present disclosure are shown. FIG. 3A is an isometric illustration of an elevator car frame 304 with the overspeed safety system 300 installed thereto. FIG. 3B is an enlarged illustration of a portion of the overspeed safety system 300 showing a relationship with a guide rail. FIG. 3C is a schematic similar to FIG. 3B, but with the guide rail removed for clarity of illustration.

The car frame 304 includes a platform 306, a ceiling 308, a first car structural member 310, and a second car structural member 312. The car frame 304 defines a frame for supporting various panels and other components that define the elevator car for passenger or other use (i.e., define a cab of the elevator), although such panels and other components are omitted for clarity of illustration. The elevator car 303 is moveable along guide rails 309, similar to that shown and described above. The overspeed safety system 300 provides a safety braking system that can stop the travel of the elevator car 303 during an overspeed event.

The overspeed safety system 300 includes a first safety brake 314, a first electromechanical actuator 316, and a controller or control system 318 operably connected to the first electromechanical actuator 316. The first safety brake 314 and the first electromechanical actuator 316 are arranged along the first car structural member 310. A second safety brake 320 and a second electromechanical actuator 322 are arranged along the second car structural member 312. The control system 318 is also operably connected to the second electromechanical actuator 322. The connection between the control system 318 and the electromechanical actuators 316, 322 may be provided by a communication line 324. The communication line 324 may be wired or wireless, or a combination thereof (e.g., for redundancy). As shown, the control system 318 is located on the top or ceiling 308 of the car frame 304. However, such position is not to be limiting, and the control system 318 may be located anywhere within the elevator system (e.g., on or in the elevator car, within a controller room, etc.). The control system 318 may comprise electronics and printed circuit boards for processing (e.g., processor, memory, communication elements, electrical buss, etc.). Thus, the control system 318 may have a very low profile and may be installed within ceiling panels, wall panels, or even within a car operating panel of the elevator car 303.

The overspeed safety system 300 is an electromechanical system that eliminates the need for a linkage or linking element installed at the top or bottom of the elevator car. The control system 318 may include, for example, a printed circuit board with multiple inputs and outputs. In some embodiments, the control system 318 may include circuitry for a system for control, protection, and/or monitoring based on one or more programmable electronic devices (e.g., power supplies, sensors, and other input devices, data highways and other communication paths, and actuators and other output devices, etc.). The control system 318 may further include various components to enable control in the event of a power outage (e.g., capacitor/battery, etc.). The control system 318 also includes an accelerometer to determine a speed of an elevator car. In such embodiments, the control system 318 is mounted to the elevator car, as shown in the illustrative embodiments herein.

The control system 318, in some embodiments, may be connected to and/or in communication with a car positioning system, an accelerometer mounted to the car (i.e., a second or separate accelerometer), and/or to the elevator controller. Accordingly, the control system 318 may obtain movement information (e.g., speed, direction, acceleration) related to movement of the elevator car along an elevator shaft. The control system 318 may operate independently of other systems, other than potentially receiving movement information, to provide a safety feature to prevent overspeed events.

The control system 318 may process the movement information provided by a car positioning system determine if an elevator car is over speeding beyond a certain threshold. If the threshold is exceeded, the control system 318 will trigger the electromechanical actuators and the safety brakes. The control system 318 will also provide feedback to the elevator control system about the status of the overspeed safety system 300 (e.g., normal operational position/triggered position).

Thus, the overspeed safety system 300 of the present disclosure enables electrical and electromechanical safety braking in the event of overspeed events. The electrical aspects of the present disclosure enable the elimination of the physical/mechanical linkages that have traditionally been employed in overspeed safety systems. That is, the electrical connections allow for simultaneous triggering of two separate safety brakes through electrical signals, rather than relying upon mechanical connections.

With reference to FIG. 3C, details of parts of the overspeed safety system 300 are shown. The first electromechanical actuator 316 is mounted to the first car structural member 310 using one or more fasteners 326 (e.g., floating fasteners). The first electromechanical actuator 316 includes an actuator pad 328 and guidance elements 330. The first electromechanical actuator 316 is operably connected to the control system 318 by the communication line 324. The control system 318 can transmit an actuation signal to the first electromechanical actuator 316 (and the second electromechanical actuator 322) to perform an actuation operation when an overspeed event is detected. The first electromechanical actuator 316 will actuate a connecting rod 332 that is operably connected to the first safety brake 314. When the connecting rod 332 is actuated, the first safety brake 314 will actuate to engage with the guide rail 309, e.g., using a safety brake element 334, such as a safety roller or wedge.

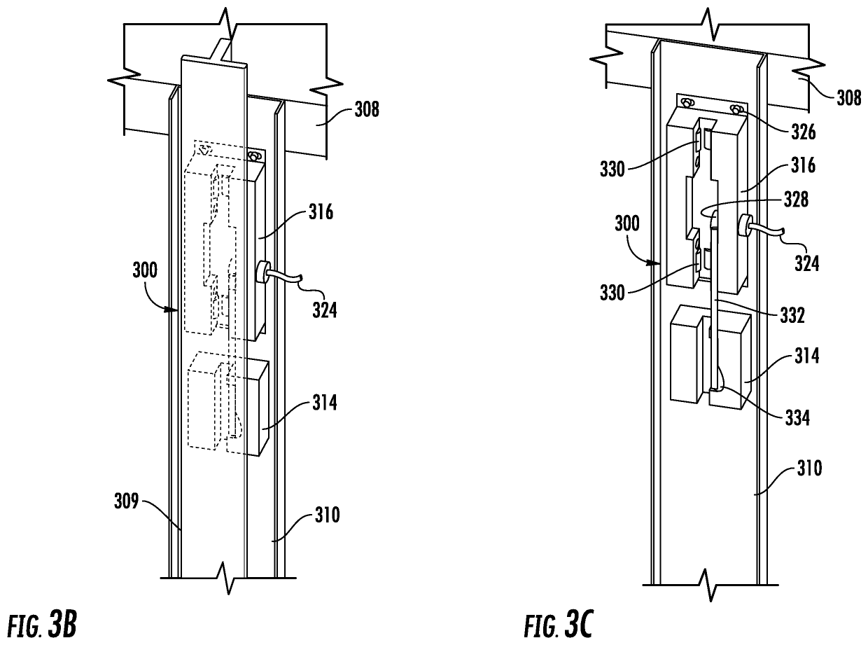

Turning now to FIG. 4, a schematic illustration of an overspeed safety system 400 in accordance with an embodiment of the present disclosure is shown. The overspeed safety system 400 may be similar to that shown and described above, and thus a detailed description thereof may be omitted. The overspeed safety system 400 includes a safety brake 414, an electromechanical actuator 416, and a control system 418, with the control system 418 in communication with the electromechanical actuator 416 through a communication line 424. FIG. 4 illustrates the positioning of components of the overspeed safety system 400 relative to a car frame 404. The car frame 404 includes a platform 406, a ceiling 408, and a car structural member 410. As shown, the control system 418, in this embodiment, is installed within the ceiling 408 of the car frame 404. In other embodiments, the control system 418 may be installed on the top of the ceiling 408 of the car frame 404 (i.e., on the exterior of the elevator car).

As shown, the safety brake 414 and the electromechanical actuator 416 are installed such that these components are below the ceiling 408 of the car frame 404 and installed within and along the car structural member 410. A distance between the platform 406 and the ceiling 408 is defined as a car height H_{C}, and the safety brake 414 and the electromechanical actuator 416 are arranged within the car height H_{C}. Specifically, in this illustrative embodiment, the safety brake 414 and the electromechanical actuator 416 are installed within an upper installation height H_{U} that is defined as a distance downward along the car structural member 410 from the ceiling 408. In some embodiments, the upper installation height H_{U} may be about 500 mm, but will be of sufficient distance to accommodate both the safety brake 414 and the electromechanical actuator 416 below the ceiling 408.

The upper installation height H_{U} may define a range of installation locations of the safety brake 414 and the electromechanical actuator 416 such that inspection, repair, or other maintenance may be performed thereon. In some embodiments, when the safety brake 414 and the electromechanical actuator 416 are installed in the upper installation height H_{U}, maintenance may be performed from an opening in the ceiling 408, such as using a foldable ceiling. It is noted that by locating the safety brake 414 and the electromechanical actuator 416 within the car structural member 410 and within the car height H_{C}, the height profile of the elevator car may be minimized (i.e., no components related to the overspeed safety system 400 may extend above the ceiling 408 of the car frame 404).

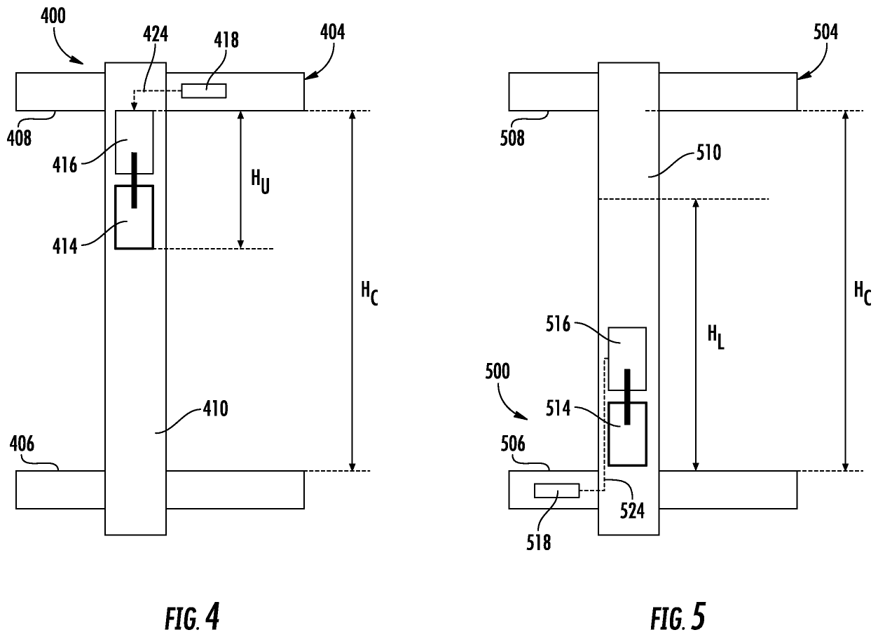

Turning now to FIG. 5, a schematic illustration of an overspeed safety system 500 in accordance with an embodiment of the present disclosure is shown. The overspeed safety system 500 may be similar to that shown and described above, and thus a detailed description thereof may be omitted. The overspeed safety system 500 includes a safety brake 514, an electromechanical actuator 516, and a control system 518, with the control system 518 in communication with the electromechanical actuator 516 through a communication line 524. FIG. 5 illustrates the positioning of components of the overspeed safety system 500 relative to a car frame 504. The car frame 504 includes a platform 506, a ceiling 508, and an car structural member 510. As shown, the control system 518, in this embodiment, is installed within the platform 506 of the car frame 504. In other embodiments, the control system 518 may be installed on the bottom of the platform 506 of the car frame 504 (i.e., on the exterior of the elevator car).

As shown, the safety brake 514 and the electromechanical actuator 516 are installed such that these components are below the ceiling 508 and above the platform 506 of the car frame 504 and installed within and along the car structural member 510. A distance between the platform 506 and the ceiling 508 is defined as a car height H_{C}, and the safety brake 514 and the electromechanical actuator 516 are arranged within the car height H_{C}. Specifically, in this illustrative embodiment, the safety brake 514 and the electromechanical actuator 516 are installed within a lower installation height H_{L} that is defined as a distance upward along the car structural member 510 from the platform 506. In some embodiments, the lower installation height H_{L} may be up to 2000 mm, but will be of sufficient distance to accommodate both the safety brake 514 and the electromechanical actuator 516 above the platform 506.

The lower installation height H_{L} may define a range of installation locations of the safety brake 514 and the electromechanical actuator 516 such that inspection, repair, or other maintenance may be performed thereon. In some embodiments, when the safety brake 514 and the electromechanical actuator 516 are installed in the lower installation height H_{L}, maintenance may be performed from an opening in a wall panel of the elevator car. It is noted that by locating the safety brake 514 and the electromechanical actuator 516 within the car structural member 510 and within the car height H_{C}, the height profile of the elevator car may be minimized (i.e., no components related to the overspeed safety system 500 may be below the platform 506 of the car frame 504).

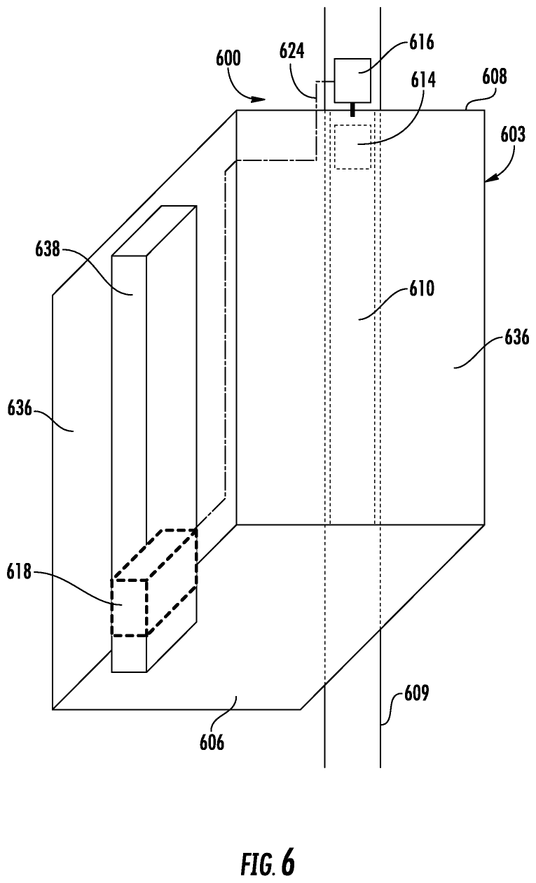

Turning now to FIG. 6, a schematic illustration of an overspeed safety system 600 installed on an elevator car 603 in accordance with an embodiment of the present disclosure is shown. The overspeed safety system 600 may be similar to that shown and described above, and thus a detailed description thereof may be omitted. The overspeed safety system 600 includes a safety brake 614, an electromechanical actuator 616, and a control system 618, with the control system 618 in communication with the electromechanical actuator 616 through a communication line 624. FIG. 6 illustrates the positioning of components of the overspeed safety system 600 relative to the elevator car 603. The elevator car 603 includes a platform 606, a ceiling 608, a car structural member 610, a plurality of panels 636, and a car operating panel 638. As shown, the control system 618, in this embodiment, is installed within the car operating panel 638 of the elevator car 603. In other embodiments, the control system 618 may be installed behind one of the panels 636 (i.e., within the cab or passenger space of the elevator car 603).

Advantageously, embodiments described herein provide overspeed safety systems that may provide safety braking to an elevator system while also minimizing the profile of such systems. For example, embodiments described herein may enable increased hoistway efficiency through minimizing the profile or extension of various components above and/or below an elevator car, such as control systems thereof. Further, positions of control systems of overspeed safety systems of the present disclosure may be advantageously located to improve ease of maintenance performed thereon (e.g., from within the elevator car, open panels, a drop-down ceiling panel, etc.). Accordingly, embodiments described herein can enable the use of low pit depths and also low overhead distances within an elevator shaft. Further, advantageously, embodiments provided herein may enable reduced hardwiring installations (e.g., reduced length of wiring), which may impact and reduce response/reaction times of such systems, thereby providing increased responsiveness in the event of an overspeed event.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. An elevator system comprising:
an elevator car movable along a first guide rail and a second guide rail within an elevator shaft, the elevator car having a car frame comprising a platform, a ceiling, a first car structural member, and a second car structural member the elevator car further comprising one or more car panels defining a cab and a car operating panel; and
an overspeed safety system comprising:
a first safety brake and a first electromechanical actuator operably connected thereto, wherein the first safety brake is operable to engage with the first guide rail to stop movement of the elevator car;
a second safety brake and a second electromechanical actuator operably connected thereto, wherein the second safety brake is simultaneously operable with the first safety brake to engage with the second guide rail to stop movement of the elevator car; and
a control system operably connected to the first electromechanical actuator and the second electromechanical actuator, the control system configured to trigger the first electromechanical actuator and the second electromechanical actuator due to at least a detected overspeed event,
wherein the control system is located on top of the ceiling, within the ceiling, beneath the platform, within the platform, behind a car panel, or within the car operating panel.

2. The elevator system of claim 1, wherein:
a distance between the platform and the ceiling is defined as a car height H_{C},
the first safety brake and the first electromechanical actuator are positioned within the first car structural member within the car height H_{C}, and
wherein the second safety brake and the second electromechanical actuator are positioned within the second car structural member within the car height H_{C}.

3. The elevator system of claim 2, wherein:
the first safety brake and the first electromechanical actuator are positioned at a respective upper installation height from the ceiling of the elevator car within the first car structural member; and
the second safety brake and the second electromechanical actuator are positioned at a respective upper installation height from the ceiling of the elevator car within the second car structural member.

4. The elevator system of claim 3, wherein the upper installation height of the first safety brake and the first electromechanical actuator and the upper installation height of the second safety brake and the second electromechanical actuator are the same upper installation height H_{U}.

5. The elevator system of claim 4, wherein the upper installation height H_{U} is about 500 mm.

6. The elevator system of claim 2, wherein:
the first safety brake and the first electromechanical actuator are positioned at a respective lower installation height from the platform of the elevator car within the first car structural member; and
the second safety brake and the second electromechanical actuator are positioned at a respective lower installation height from the ceiling of the elevator car within the second car structural member.

7. The elevator system of claim 6, wherein the lower installation height of the first safety brake and the first electromechanical actuator and the lower installation height of the second safety brake and the second electromechanical actuator are the same lower installation height H_{L}.

8. The elevator system of claim 7, wherein the lower installation height H_{L} is about 2000 mm.

9. The elevator system of claim 1, further comprising a communication line connecting the control system to the first electromechanical actuator and the second electromechanical actuator.

10. The elevator system of claim 9, wherein the communication line is at least one of a wired connection and a wireless connection.

11. The elevator system of claim 2, further comprising a communication line connecting the control system to the first electromechanical actuator and the second electromechanical actuator.

12. The elevator system of claim 3, further comprising a communication line connecting the control system to the first electromechanical actuator and the second electromechanical actuator.

13. The elevator system of claim 4, further comprising a communication line connecting the control system to the first electromechanical actuator and the second electromechanical actuator.

14. The elevator system of claim 5, further comprising a communication line connecting the control system to the first electromechanical actuator and the second electromechanical actuator.

15. The elevator system of claim 6, further comprising a communication line connecting the control system to the first electromechanical actuator and the second electromechanical actuator.

16. The elevator system of claim 7, further comprising a communication line connecting the control system to the first electromechanical actuator and the second electromechanical actuator.

17. The elevator system of claim 8, further comprising a communication line connecting the control system to the first electromechanical actuator and the second electromechanical actuator.
